(19) United States
(12) Patent Application Publication
(10) Pub. No.: US 2020/0187721 A1
(43) Pub. Date: Jun. 18, 2020

(54) FOOD ARTICLE CUTTING BOARD AND RELATED METHOD

(71) Applicant: Earl Carter, Dearborn Heights, MI (US)

(72) Inventor: Earl Carter, Dearborn Heights, MI (US)

(21) Appl. No.: 16/797,743

(22) Filed: Feb. 21, 2020

Related U.S. Application Data
(60) Provisional application No. 62/837,775, filed on Apr. 24, 2019.

(51) Int. Cl. A47J 47/00; B26D 5/10; B26D 7/20; B26D 7/22; B26D 1/30

(52) U.S. Cl. CPC A47J 47/005; B26D 5/10; B26D 7/20; B26D 2007/0018; B26D 1/30; B26D 2210/02; B26D 7/225

(57) ABSTRACT

The present invention is directed to a cutting board for cutting food articles into parts. The cutting board having a pair of long sides and a pair of short sides defining an area of the cutting board. A lateral groove extends between the pair of long sides and differentiates the area of the board into a first platform and a second platform. The area is further differentiated into a third platform which is adjacent to the second platform. A blade pivotally coupled to the end of the lateral groove. The cutting board further comprises a finger guard and a food stopper.

### CROSS-REFERENCE TO RELATED APPLICATIONS

This application claims priority to the U.S. provisional patent application Ser. No. 62/837,775 filed Apr. 24, 2019 which is incorporated herein by reference in its entirety.

### FIELD OF INVENTION

The present invention relates to an apparatus and method for cutting food articles, and in particular, to an apparatus for facilitating cutting off food articles into parts, especially vegetables.

### BACKGROUND

Food is essential for life and preparation of food generally involves a step of cutting down food particles into smaller parts. Food articles herein refer to both plant and animal products including fruits and vegetables. A knife is a vital and usually used tool for cutting food articles into parts. Be it a home cooking or professional cooking in a restaurant, knives are used to cut food articles into parts. Cutting food articles using a knife is a skill and mishandling of a knife can cause injuries. Moreover, the skill of cutting food articles include cutting the food articles into consistent-sized parts. Consistent-sized parts of food articles have an aesthetic appearance and are convenient to eat, cook or handle. The skill of food cutting using a knife, like any other skill, improves with practice.

However, knife-related injuries while cutting food articles are also very common. Beginners who have just started using the knife for food cutting are more susceptible to get injured by the knife. Still, it is not uncommon that a skilled person may also sometimes mishandle the knife and get injured. This generally happens when a person loses focus while cutting the food articles or is cutting the food articles in bulk. Old aged people with declining fine motor skills usually find it difficult and dangerous to work with knives. The fine-motor skills of a person can get affected by age, disease or disorder. Besides the risk of injury, cutting off the consistent size parts can be a daunting task for peoples with declining fine motor skills.

Thus, a long-felt need is appreciated for an apparatus that may permit cutting down food articles into parts more safely than a knife. In particular, a long-felt need is appreciated for an apparatus that allows people with declining fine motor skills to safely cut the food articles into consistently sized parts.

### SUMMARY OF THE INVENTION

The principal objective of the present invention is therefore directed to a cutting board for food articles that addresses one or more problems of using knives for cutting food articles.

It is an additional objective of the present invention that the cutting board can be used safely and efficiently by a novice.

It is a further objective of the present invention that the cutting board can be safely used by people with declining motor skills.

It is another objective of the present invention that the cutting board allows cutting off food articles into consistently sized parts.

Yet another objective of the present invention is that the cutting board is economic to manufacture and easier to use.

In one aspect the present invention is directed to a cutting board for cutting food articles into parts, the cutting board having a first short side, a second short side, a first long side and a second long side defining an area of the board, the area of board differentiated into a first platform, a second platform, and a third platform, the first platform is adjacent to the first short side, the second platform is adjacent to the first platform, and the third platform is adjacent to the second platform, the first platform and the second platform are co-planar, the third platform slopes downwards towards the second short side forming a ramp. The third platform can be removably coupled to the second platform. A lateral groove that extends between the first long side and the second long side, the lateral groove configured between the first platform and the second platform, the lateral groove is having a first end and an opposite second end; and a blade having a proximal end and a distal end, the proximal end pivotally coupled to the first end of the lateral groove and the distal end configured with a handle.

In another aspect, the cutting board further comprises a finger guard coupled to the first platform adjacent to the lateral groove, the finger guard having a front opening and a rear opening defining a passageway, the passageway configured to permit a food article to pass through. The finger guard can be removably coupled to the first platform, wherein a plurality of male members can be configured at the underside of the finger guard and the cutting board can be configured with corresponding female members, the male members mate with the female members. In one case, the male members are protrusions and the female members are grooves, the protrusion snaps into the grooves.

In another aspect, the cutting board further comprises a food stopper mounted to the second platform adjacent to the lateral groove, the food stopper configured to restrict the movement of a food article being cut-off to cut the food article into similar sized parts. The food stopper can be removably coupled to the cutting board, wherein the distance of the food stopper from the lateral groove can be varied. To vary the distance between the lateral groove and the food stopper, a plurality of female attachments spaced apart at distances from the lateral groove can be configured in the cutting board. The food stopper can be attached to one of the plurality of female attachments.

In another aspect, the cutting board is rectangular having the first-long side and the second-long side parallel to one another and the first short side and the second short side parallel to one another and perpendicular to the first long side.

These and other objects and advantages of the embodiments herein will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a top and right perspective view of a cutting board, according to a preferred embodiment of the present invention; and,

FIG. 2 is a top and left perspective view of the cutting board of FIG. 1, according to a preferred embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

All the implementations described below are exemplary implementations provided to enable persons skilled in the art to make or use the embodiments of the disclosure and are not intended to limit the scope of the disclosure, which is defined by the claims.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

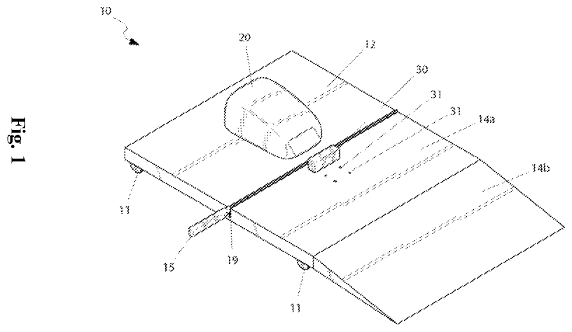

The present invention is directed to a cutting board for food articles, such as vegetables, fruits, and meat products. Shown in FIG. 1 is a top right perspective view of an exemplary embodiment of the cutting board 10, according to the present invention. The cutting board 10 shown in FIG. 1 is of a rectangular configuration having a pair of long sides which are parallel to one another and a pair of short sides which are parallel to one another and perpendicular to the longer sides. It will be appreciated that the above rectangular-shaped cutting board 10 is a preferred embodiment, however, the cutting board 10 can be embodied in any other shape without departing from the scope of the present invention. For example, in one case, the corners of the cutting board 10 can be rounded. In another case, one of the edges of the cutting board 10 can be rounded. The cutting board 10 can be made of any food compatible rigid material, known to a skilled person for preparing articles for food. In a preferred embodiment, the cutting board 10 can be made of a wooden or plastic construction capable of being washed and withstand repeated blunt forces applied thereto without cracking or splintering.

The cutting board 10, as shown in FIG. 1, can be differentiated into three distinct portions, first platform 12, second platform 14a, and third platform 14b. The first platform 12 is adjacent to the short side and has a planar upper surface. The first platform 12 can be provided as a feed platform, wherein the food article to be cut can be placed. For example, the vegetables can be placed on the first platform 12 for cutting. The second platform 14a is adjacent to the first platform 12 and the upper surface of the second platform 14a is also planar. A lateral groove 19 differentiate the first platform 12 and the second platform 14a. The second platform 14a can be provided as a food parts platform, wherein the food articles cut into parts can be collected. The third platform 14b is adjacent to the second platform 14a and the short side. While the first platform 12 and the second platform 14a are co-planar, the second platform 14a and the third platform are not co-planar, but the third platform 14b slopes downward starting from the side adjacent to the second platform 14a towards the short side of the cutting board 10 forming a ramp. The third platform 14b can be removably coupled to the second platform 14a.

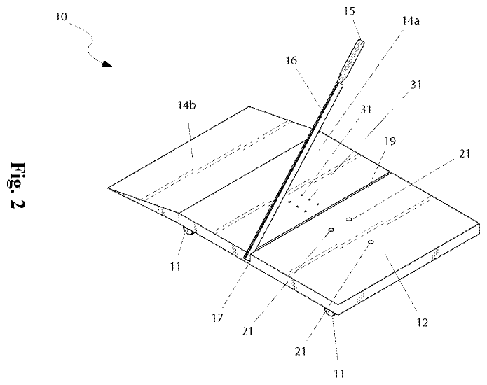

The lateral groove 19 extends between the pair of long sides. A blade 16 can be pivotally coupled to one end of the lateral groove 19, such that the sharp edge of the blade 16 lands into the lateral groove 19. As shown in FIG. 1, the blade 16 can have a proximal end and a distal end. The proximal end of the blade 16 is pivotally coupled to the first end of the lateral groove 19. The first end of the lateral groove 19 is on the left side of the cutting board 10 considering third-platform 14b as the front and the first platform 12 as the rear of the cutting board 10. The pivot joint 17 shown in FIG. 2 permits the blade 16 to pivot vertically. It will be appreciated by a skilled person that the pivot joint can be provided in one of the different known ways for pivotally mounting a blade to a stationary platform known in the art. For example, a bracket can be coupled to the long side of the cutting board at the first end of the lateral groove 19 to couple the blade 16. The distal end of the blade 16 is provided with an ergonomic blade handle 15. The handle 15 can be grasped by a hand of a user to pivot the blade against the lateral groove 19. The handle 15 can be made of any suitable material that is both durable and comfortable to the hands of the user. For example, the handle can be made of wood or plastic material. The ergonomic shape of the handle 15 can be configured to provide a better grip and preventing slipping of the hand towards the sharp edge of the blade 16. Further, as shown in FIGS. 1 and 2, the length of the blade between the pivot joint 17 and the handle 15 is equal or more than the width of the cutting board 10. Additional alternate embodiments may provide for the cutting board 10 to employ a safety bar or locking mechanism to positively lock the blade 16 fully within the lateral groove 19, while the cutting board is not in use or for storage of the cutting board 10.

Further, it is shown in FIG. 1 is a finger guard 20 mounted on the first platform 12 adjacent to the lateral groove 19. In a preferred embodiment, the finger guard 20 can be positioned centrally, but it is within the scope of the present invention to position the finger guard 20 closer to the left or right long sides of the cutting board 10. The finger guard 20 shown in FIG. 1 is dome-shaped having a curvilinear upper side. The front end and the rear end of the finger guard 20 are open and define a passageway. The front end of the finger guard 20 faces the lateral groove 19, while the rear end opens opposite to the front end. The passageway defined in the finger guard 20 permits a food article to pass through towards the lateral groove 19 but restricts or safeguard the hand from reaching the lateral groove 19. The food article can be inserted from the rear end of the finger protector 20 towards the blade 16, wherein the inserted food article can be cut by the blade 16, while the hands of the user are safeguarded by the finger guard 20.

In a preferred embodiment, the finger guard 20 can be removably mounted to the cutting board 10, wherein the user can remove the finger guard 20 when not desired. To removably mount the finger guard 20 to the cutting board 10, a coupling mechanism can be provided. FIG. 2 shows an exemplary embodiment of the coupling mechanism, which is a male member, or a protrusion provided on the underside of the finger guard 20. Corresponding female member 21 shown in FIG. 2 can be provided on the first platform 12, wherein the male member can mate or Snap-On to the female member 21.

Further is shown in FIG. 1 is a food stopper 30, which is a rectangular shape prism positioned adjacent to the lateral groove 19 and colinear with the finger guard 20. The food stopper 30 provides a barrier to the food article being cut-off in order to get consistently sized parts. For example, a user can place the food article against the food stopper 30 and the blade is struck over the food article to divide it into parts. The size of the parts will be proportional to the distance between the lateral groove and the food stopper 30. The food stopper 30 can be used with or without the finger guard 20. The food articles can be inserted from the rear end of the finger guard 20 towards the food stopper 30 to cut consistently sized food article parts. To further cut off the food article, the remaining portion of the food article can be pushed again towards the food stopper 30, wherein the food article pushes the cut parts to topple over the food stopper 30 and collected behind the food stopper 30. To vary the size of food article parts being cut-off, the position of the food stopper 30 can be varied. As shown in FIGS. 1 and 2, multiple pairs of slots are provided in the second platform 14a. FIG. 2 shows three such pairs spaced apart at distances from the lateral groove 19. The food stopper 30 can be mounted to any of these pairs to increase or decrease the distance of the food stopper 30 from the lateral groove 19 and thus, to increase or decrease the size of food article parts being cut-off. Additional embodiments may provide for having indicia printed or labeled or otherwise located on the surface of the cutting board 10 adjacent to or aligned with the food stopper 30 to show the exact sizes that the food article can be cut to. The food article parts collected on the second platform 14a can be moved to the third platform 14b for subsequent collection or cooking thereof.

FIGS. 1 and 2 further show a plurality of feet 11 attached, either removably or fixedly, to the underside of the cutting board 10. The cutting board 10 can be placed over a rigid surface, such as kitchen countertops. The feet 11 can be made form a material that is non-slippery and provides stability to the cutting board while cutting the food articles. Preferably four feet can be placed at four corners of the cutting board 10 to ensure even weight distribution and steadiness on the rigid surface when in use. The feet 11 can preferably be made of rubber that is capable of minimal compression and conformity to provide a non-slipping and force absorbing placement on the rigid surface.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cutting board for cutting food articles into parts, the cutting board comprising:
a board having a first-short side, a second-short side, a first-long side and a second-long side defining an area of the board, the area of board differentiated into a first platform, a second platform, and a third platform, the first platform is adjacent to the first-short side, the second platform is adjacent to the first platform, and the third platform is adjacent to the second platform, the first platform and the second platform are co-planar, the third platform slopes downwards towards the second-short side forming a ramp, the third platform removably coupled to the second platform;
a lateral groove that extends between the first-long side and the second-long side, the lateral groove configured between the first platform and the second platform, the lateral groove having a first end and an opposite second end; and
a blade having a proximal end and a distal end, the proximal end pivotally coupled to the first end of the lateral groove and the distal end configured with a handle.

2. The cutting board of claim 1, wherein the cutting board further comprises a finger guard coupled to the first platform adjacent to the lateral groove, the finger guard having a front opening and a rear opening defining a passageway, the passageway configured to permit a food article to pass-through.

3. The cutting board of claim 2, wherein the finger guard is removably coupled to the first platform.

4. The cutting board of claim 3, wherein a plurality of male members configured at underside of the finger guard and the cutting board having corresponding female members, the male members mate with the female members.

5. The cutting board of claim 4, wherein the plurality of male members are protrusions and the female members are grooves, the protrusion snaps into the grooves.

6. The cutting board of claim 1, wherein the cutting board further comprises a food stopper mounted to the second platform adjacent to the lateral groove, the food stopper configured to restrict movement of a food article being cut-off in order to cut the food article into similar sized parts.

7. The cutting board of claim 6, wherein the food stopper is removably coupled to the cutting board.

8. The cutting board of claim 7, wherein distance of the food stopper from the lateral groove can be varied.

9. The cutting board of claim 8, wherein the cutting board comprises a plurality of female attachments spaced apart at distances from the lateral groove, the food stopper can be attached to one of the plurality of female attachments.

10. The cutting board of claim 1, wherein the cutting board is rectangular having the first-long side and the second-long side parallel to one another, and the first-short side and the second-short side parallel to one another and perpendicular to the first long side.

11. A method of cutting a food article into parts, the method comprises:
providing a cutting board, the cutting board comprising:
a board having a first-short side, a second-short side, a first-long side and a second-long side defining an area of the board,
a lateral groove that extends between the first-long side and the second-long side, the lateral groove differentiates the area of the cutting board into a first platform and a second platform, the first platform adjacent to the first short side, the lateral groove having a first end and an opposite second end,
a blade having a proximal end and a distal end, the proximal end pivotally coupled to the first end of the lateral groove and the distal end configured with a handle,
a finger guard coupled to the first platform adjacent to the lateral groove, the finger guard having a front opening and a rear opening defining a passageway, the passageway configured to permit the food article to pass through, and
a food stopper mounted to the second platform adjacent to the lateral groove and collinear with the finger guard, the food stopper configured to restrict movement of a food article being cut-off in order to cut the food article into same sized parts;
inserting the food article through the passageway towards the food stopper; and
striking the blade to cut-off the food article into parts.

12. The method of claim 11, wherein the second platform further comprises a plurality of attachment members spaced apart at distances from the lateral member, the food stopper mounted to the second platform through one of the plurality of attachment members, and wherein the method further comprises a step of mounting the food stopper to one of the plurality of attachment member, wherein distance between the lateral groove and the one of the plurality of attachment member is proportional to desired size of the parts.

13. The method of claim 11, wherein the cutting board further comprises a third platform, the third platform removably coupled to the second platform, and wherein the method further comprises moving the parts from the second platform to the third platform.

14. The method of claim 13, wherein the first platform and the second platform are coplanar, the third platform slopes towards the second-short side forming a ramp.

15. The method of claim 11, wherein the method further comprises a step of pushing a remaining portion of the food article through the passageway causing the parts to topple over the food stopper and collect behind the food stopper.

16. The method of claim 11, wherein the finger guard is removably coupled to the cutting board.

17. The method of claim 11, wherein the food article is vegetable.

18. The method of claim 11, wherein the cutting board further comprises a measurement scale configured adjacent to the food stopper, the measurement scale extends form the lateral groove.
